(19) United States
(12) Patent Application Publication
(10) Pub. No.: US 2022/0398574 A1
(43) Pub. Date: Dec. 15, 2022

(54) DOCUMENT ROLE-BASED SIGNATURE FIELD PLACEMENT

(71) Applicant: Citrix Systems, Inc., Fort Lauderdale, FL (US)

(72) Inventors: Manbinder Pal Singh, Coral Springs, FL (US); Maanusri Balasubramanian, Chennai (IN)

(21) Appl. No.: 17/343,106

(22) Filed: Jun. 9, 2021

(51) Int. Cl. G06Q 20/38; G06Q 50/18; G06F 40/186; G06K 9/00

(52) U.S. Cl. CPC G06Q 20/3825; G06Q 50/18; G06F 40/186; G06K 9/00463; G06K 2209/01

(57) ABSTRACT

Techniques for preparing a document for electronic signature by multiple persons involve identifying locations within a document at which different persons are to provide signatures based content of the document and information about roles of the different persons to complete a transaction with use of the document. The techniques further involve modifying the document or an image of that document to include input fields at the identified locations, the input fields being configured to receive electronic signatures. The techniques further involve providing a modified version of the document or image that includes the input fields for the different persons to electronically sign. Document preparation using such techniques is easy, efficient, and accurate.

### BACKGROUND

A conventional electronic signature application enables multiple parties to electronically sign contracts, leases, and purchase and sale agreements from their respective electronic devices. Such an application alleviates the need for the parties to appear at a physical location and sign in person. Later, the fully signed copy may be made electronically accessible to all parties.

### SUMMARY

To prepare an agreement using the above-described conventional electronic signature application, a human preparer positions an electronic signature field over a signing area of the agreement. The human preparer then assigns (or links) the field to a particular party involved in the agreement to prevent the wrong party from electronically signing that field. The human preparer performs this positioning and assigning process for each signing party involved in the agreement.

After the human preparer has properly added all of the electronic signature fields to the agreement, the signing parties access the agreement from their respective electronic devices to individually enter electronic signatures into the appropriate electronic signature fields. The agreement is considered completed once all of the parties have electronically signed all of the fields.

Unfortunately, a human preparer is required to manually place electronic signature fields over signing areas of the agreement, and assign the electronic signature fields to the proper signing parties. Such work can be tedious, time consuming, and prone to error. In some situations, the human preparer may attempt to start with an agreement template that already includes electronic signature fields. Along these lines, the agreement template may be a contract having a certain number of pre-existing fields for buyers and sellers to sign (e.g., six places for sellers to sign and six places for buyers to sign). However, the actual number of signing parties may be different (e.g., two sellers and four buyers). Here, the human preparer must still manually delete (or add) signature fields, and then properly assign the signature fields to the buyers and sellers. Accordingly, the work of the human preparer is still challenging and tedious.

Moreover, the work of human preparer may be exacerbated under certain circumstances. For example, for a single agreement that is 40-50 pages long in which the parties are required to sign each page, there is considerable effort required of the human preparer even though there is only one agreement. As another example, the human preparer may be a broker or agent (e.g., for weekly boat rentals, etc.) tasked with routinely preparing 100s or even 1000s of such agreements on a regular or highly frequent basis which may be extremely burdensome.

In contrast to the above-described conventional electronic signature application which requires a human preparer to manually place and assign each electronic signature field to an agreement, improved techniques utilize automated role-based signature field placement during document preparation. Such techniques involve identifying signing locations within a document using information about roles of different persons to complete a transaction with use of the document. The document (or an image of the document) may then be modified automatically to include input fields for the different persons to electronically sign. Accordingly, document preparation using the improved techniques is easy, efficient, and accurate.

One embodiment is directed to a method of preparing a document for electronic signature by multiple persons. The method includes identifying locations within a document at which different persons are to provide signatures based content of the document and information about roles of the different persons to complete a transaction with use of the document. The method further includes modifying the document or an image of that document to include input fields at the identified locations, the input fields being configured to receive electronic signatures. The method further includes providing a modified version of the document or image that includes the input fields for the different persons to electronically sign.

Another embodiment is directed to electronic circuitry that includes memory, and control circuitry coupled with the memory. The memory stores instructions that, when carried out by the control circuitry, cause the control circuitry to perform a method that includes:
(A) identifying locations within a document at which different persons are to provide signatures based content of the document and information about roles of the different persons to complete a transaction with use of the document;
(B) modifying the document or an image of that document to include input fields at the identified locations, the input fields being configured to receive electronic signatures; and
(C) providing a modified version of the document or image that includes the input fields for the different persons to electronically sign.

Yet another embodiment is directed to a computer program product having a non-transitory computer readable medium which stores a set of instructions to prepare a document for electronic signature by multiple persons. The set of instructions, when carried out by computerized circuitry, causes the computerized circuitry to perform a method of:
(A) identifying locations within a document at which different persons are to provide signatures based content of the document and information about roles of the different persons to complete a transaction with use of the document;
(B) modifying the document or an image of that document to include input fields at the identified locations, the input fields being configured to receive electronic signatures; and
(C) providing a modified version of the document or image that includes the input fields for the different persons to electronically sign.

In some arrangements, identifying the locations within the document includes detecting possible signing areas on the image of the document, and discerning the locations from the possible signing areas based on signer entries describing signing parties. The signer entries stores the information about the roles of the different persons.

In some arrangements, detecting the possible signing areas on the image includes applying at least one of computer vision, image processing and optical character recognition to the image to deduce the possible signing areas from the image.

In some arrangements, the signer entries includes a first signer entry describing a first signing party and a second signer entry describing a second signing party. Additionally, discerning the locations from the possible signing areas includes selecting a first possible signing area as a first location for the first signing party to electronically sign, and selecting a second possible signing area as a second location for the second signing party to electronically sign.

In some arrangements, the method further includes, prior to identifying the locations within the document, creating the signer entries describing the signing parties, the signer entries defining signing roles for the signing parties.

In some arrangements, discerning the locations from the possible signing areas includes binding the signing roles defined by the signer entries to the possible signing areas.

In some arrangements, discerning the locations from the possible signing areas further includes, after the signing roles defined by the signer entries are bound to the possible signing areas, mapping the signing parties to at least some of the possible signing areas to select the locations.

In some arrangements, mapping the signing parties includes mapping a particular signing party to multiple possible signing areas to identify multiple locations for the particular signing party.

In some arrangements, the image includes more possible signing areas than there are signing parties. Additionally, discerning the locations from the possible signing areas further includes leaving at least one possible signing area unmapped based on the image including more possible signing areas than there are signing parties.

In some arrangements, the image includes less possible signing areas than there are signing parties. Additionally, discerning the locations from the possible signing areas further includes adding at least one possible signing area on the image to enable mapping each signing party to a possible signing area on the image.

In some arrangements, the signer entries are arranged in a signer order. Additionally, mapping the signing parties includes assigning the signer entries to the possible signing areas on the image in accordance with the signer order to preserve the signer order when subsequently modifying the document or image to include the input fields.

In some arrangements, the document represents an agreement. Additionally, the signer entries includes a first set of signer entries and a second set of signer entries. The signing role defined by each signer entry of the first set is a first contractual role in the agreement, and the signing role defined by each signer entry of the second set is a second contractual role in the agreement that is different from the first contractual role.

In some arrangements, discerning the locations from the possible signing areas includes assigning field types to the locations, the field types defining different types of input requested from the signing parties.

In some arrangements, modifying the document or image to include the input fields includes placing the input fields at the locations in accordance with the assigned field types.

In some arrangements, the method further includes rendering a view of the modified version of the document, the view including the image of the document and the input fields placed at the locations on the image.

Another embodiment is directed to a method of preparing a document for electronic signing. The method includes performing an electronic contextual determination operation on an image of the document to identify signing locations on the image. The method further includes situating signing fields at the signing locations. The method further includes outputting a prepared version of the document, the prepared version including the image of the document and the signing fields situated at the signing locations.

In some arrangements, performing the electronic contextual determination operation includes applying at least one of computer vision, image processing and optical character recognition to the image to deduce possible signing areas from the image.

In some arrangements, the method further includes, prior to performing the electronic contextual determination operation, creating signer entries describing signing parties, the signer entries defining signing roles for the signing parties. Additionally, performing the electronic contextual determination operation further includes identifying the signing locations from the possible signing areas based on the signer entries describing the signing parties.

In some arrangements, the signer entries include name fields storing individual party names of the signing parties, role fields storing distinct roles for the signing parties, and contact information fields storing contact information for the signing parties. Such signer entries may include other fields storing other information as well.

Other embodiments are directed to electronic systems and apparatus, processing circuits, computer program products, and so on. Some embodiments are directed to various methods, electronic components and equipment that are involved in utilizing automated role-based signature field placement during document preparation.

### BRIEF DESCRIPTION OF THE DRAWINGS

The foregoing and other objects, features and advantages will be apparent from the following description of particular embodiments of the present disclosure, as illustrated in the accompanying drawings in which like reference characters refer to the same parts throughout the different views. The drawings are not necessarily to scale, emphasis instead being placed upon illustrating the principles of various embodiments of the present disclosure.

FIG. 1 is a block diagram of a computing environment that utilizes automated role-based signature field placement during document preparation in accordance with certain embodiments.

FIG. 2 is a flowchart of a procedure that is performed by electronic circuitry of the computing environment in accordance with certain embodiments.

FIG. 3 is a view of certain details of an example document in accordance with certain embodiments.

FIG. 4 is a view of certain details of signing entries in accordance with certain embodiments.

FIG. 5 is a view of certain document preparation details in accordance with certain embodiments.

FIG. 6 is a view of certain details of a modified version of an example document in accordance with certain embodiments.

FIG. 7 is a view of an electronic device which is suitable for performing automated role-based signature field placement during document preparation in accordance with certain embodiments.

FIG. 8 is a block diagram of a virtualization server which is suitable for providing document preparation and signing services within the computing environment in accordance with certain embodiments.

FIG. 9 is a sequence diagram illustrating certain activities and communications in accordance with certain embodiments.

FIG. 10 is a schematic block diagram of a cloud computing environment in which various aspects of the disclosure may be implemented.

### DETAILED DESCRIPTION

An improved technique utilizes automated role-based signature field placement during document preparation. Such a technique involves identifying signing locations within a document using information about roles of different persons to complete the document for purpose of making a transaction or other binding arrangement between multiple parties. Such identification may involve electronic contextual determination using computer vision, image processing and/or optical character recognition to deduce possible signing areas within the document (or within an image of the document). The document (or the image) may then be modified automatically to include input fields for the different persons to electronically sign. Accordingly, document preparation using the improved techniques is easy, efficient, and more accurate (i.e., less prone to human error).

The individual features of the particular embodiments, examples, and implementations disclosed herein can be combined in any desired manner that makes technological sense. Moreover, such features are hereby combined in this manner to form all possible combinations, permutations and variants except to the extent that such combinations, permutations and/or variants have been explicitly excluded or are impractical. Support for such combinations, permutations and variants is considered to exist in this document.

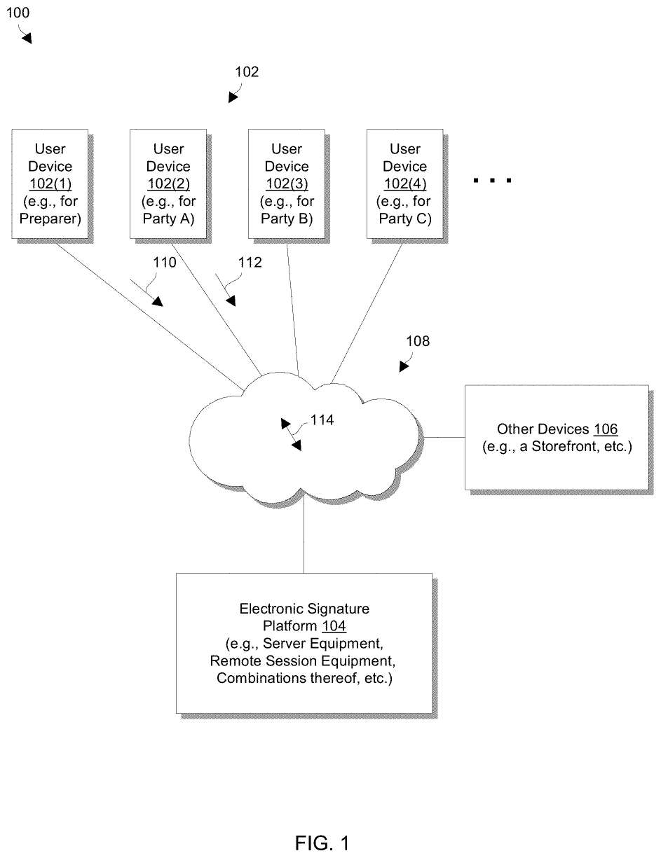

FIG. 1 shows a computing environment 100 that utilizes automated role-based signature field placement during document preparation in accordance with certain embodiments. The computing environment 100 includes user devices 102(1), 102(2), 102(3), 102(4), . . . (collectively, user devices 102), an electronic signature platform 104, other devices 106, and a communications medium 108. For illustration purposes and as will be explained in further detail below, the computing environment 100 may provide a virtual desktop infrastructure (VDI) where one or more of the user devices 102 operates as a virtual desktop client that enables a user to control a remote desktop session hosted by the electronic signature platform 104 which operates as remote session equipment. Additionally, the computing environment 100 may be implemented as a cloud computing environment in which there is delivery of shared computing services and/or resources (e.g., infrastructures to support web and other related cloud services) to multiple users or tenants.

The user devices 102 are equipped with user interfaces (e.g., electronic displays, touchscreens, keyboards, pointing apparatus, combinations thereof, etc.) that enable human users operating the user devices 102 to perform useful work. Examples of suitable user devices 102 include smartphones, tablets, laptops, desktop computers, workstations, application specific or dedicated computerized equipment, combinations thereof, and so on.

By way of example, the user devices 102 are operated by a variety of different users that participate in preparation of a document for electronic signature and electronic signing. Along these lines, the user device 102(1) may be operated by a preparer, the user device 102(2) may be operated by Party A (e.g., a seller), the user device 102(3) may be operated by Party B (e.g., another seller), the user device 102(4) may be operated by Party C (e.g., a buyer), and so on. Each user (or party) has a particular role as a signer. The particular roles (e.g., seller, buyer, lessor, lessee, borrower, lender, offeror, etc.) may vary based on the particular type of document (e.g., a purchase agreement, a rental agreement, a loan agreement, an offer letter, etc.).

In accordance with certain embodiments, a role is a distinct part or function performed by a signing party. Such roles may be uniquely identified and/or ranked such as buyer1, buyer2, seller1, seller2, renter1, renter2, etc. depending on the importance or level of significance of the signer, the type of document, the signing circumstances, and so on.

The electronic signature platform 104 is constructed and arranged to facilitate preparation of a document for electronic signature in response to document preparation input 110 from one or more user devices 102. Similarly, the electronic signature platform 104 is constructed and arranged to facilitate completion of the document in response to electronic signing input 112 from one or more user devices 102.

For document preparation, since the user device 102(1) is described above as being operated by a preparer, the user device 102(1) is shown in FIG. 1 as providing the document preparation input 110 to the electronic signature platform 104. In response to the document preparation input 110, the electronic signature platform 104 identifies locations within the document (or document image) and includes input fields at the identified locations. The electronic signature platform 104 then provides a modified version of the document or image that includes the input fields for different persons (e.g., Party A, Party B, Party C, etc.) to electronically sign.

For document completion, the various parties enter the signing input 112 (e.g., electronic signatures) via their respective user devices 102 to electronically sign the document. For example, Party A may enter respective signing input 112 via the user device 102(2), Party B may enter respective signing input 112 via the user device 102(3), Party C may enter respective signing input 112 via the user device 102(4), and so on. The document is considered to be fully completed once all of the parties have completed all of the fields.

It should be understood that the equipment for the electronic signature platform 104 may be centrally located. Alternatively, such equipment may be distributed among different locations. Examples include mainframes, clusters, cloud-based systems, datacenters, combinations thereof, and so on.

The other devices 106 represent other electronic apparatus that may be involved in preparing and/or completing a document. For example, a device 106 may operate as a storefront through which the preparer may enroll for an electronic signature service that enables the preparer to prepare documents for electronic signing. As another example, another device 106 may be operated by an entity or organization that uses the document after the document is completed (e.g., a document recordation server or registry, a website for a merchant, an appointment or scheduling system, etc.), and so on.

The communications medium 108 is constructed and arranged to connect the various components of the computing environment 100 together to enable these components to exchange electronic signals 114 (e.g., see the double arrow 114). At least a portion of the communications medium 108 is illustrated as a cloud to indicate that the communications medium 108 is capable of having a variety of different topologies including backbone, hub and spoke, loop, irregular, combinations thereof, and so on. Along these lines, the communications medium 108 may include copper based data communications devices and cabling, fiber optic devices and cabling, wireless devices, combinations thereof, etc. Furthermore, the communications medium 108 is capable of supporting a variety of communications types such as Ethernet-based communications, cellular communications, plain old telephone service (POTS) communications, combinations thereof, and so on.

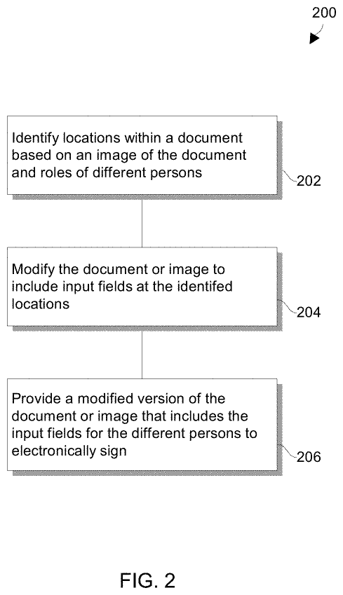

In some situations, at least a portion of the computing environment 100 utilizes a virtualization platform that runs virtual machines (VMs) for scalability, load balancing, fault tolerance, and so on. Additionally, in some situations, the computing environment 100 delivers cloud-based computing services and/or resources to multiple users or tenants (e.g., infrastructures for cloud and web services). In some arrangements, one or more components of the computing environment 100 (e.g., the electronic signature platform, a storefront, etc.) are co-located in a datacenter (e.g., hosted on one or more data center servers) which utilizes the virtualization platform. Further details will now be provided with reference to FIG. 2.

FIG. 2 is a flowchart of a procedure 200 for preparing a document for electronic signature by multiple persons in accordance with certain embodiments. The procedure 200 may be performed by electronic circuitry of the computing environment 100 (FIG. 1). Such electronic circuitry may reside at the electronic signature platform and/or at one or more other devices such as the user device 102 of the preparer.

It should be understood that the procedure 200 may be started in response to a command from the preparer. Along these lines, the preparer may initially provide signer entries that identify signing parties, roles for the signing parties, and perhaps other information such as email addresses for the signing parties. After the preparer has provided the signer entries, the preparer instructs the electronic circuitry to perform the procedure 200.

At 202, the electronic circuitry identifies locations within a document at which different persons are to provide signatures based on an image of the document and information about roles of the different persons to complete a transaction with use of the document, as will be described in more detail below. For example, for a purchase and sale agreement, the electronic circuitry may identify locations for one or more buyers, and other locations for one or more sellers.

At 204, the electronic circuitry modifies the document or image to include input fields at the identified locations, as will be described in further detail below. The input fields are objects (or constructs) configured to receive electronic signatures, i.e., electronic input provided by the different persons acting as parties in the document. It should be understood that the electronic circuitry may further include other types of fields such as gender boxes, title fields, suffix fields, other selection/answer boxes and GUI widgets, and so on for completion by the different persons.

At 206, the electronic circuitry provides a modified version of the document or image that includes the input fields for the different persons to electronically sign. The modified version may further include other details such as a date of creation, a name of a responsible preparer, instructions for completing the document, and so on.

At this point, the preparer may review the document and perhaps make adjustments as seen fit. Once the preparer considers the document ready for completion, the preparer notifies the signing parties that the document is ready for electronic signature. For example, the preparer may provide a command to the electronic circuitry that directs the electronic circuitry to send respective email messages to the signing parties with instructions and network links to the document.

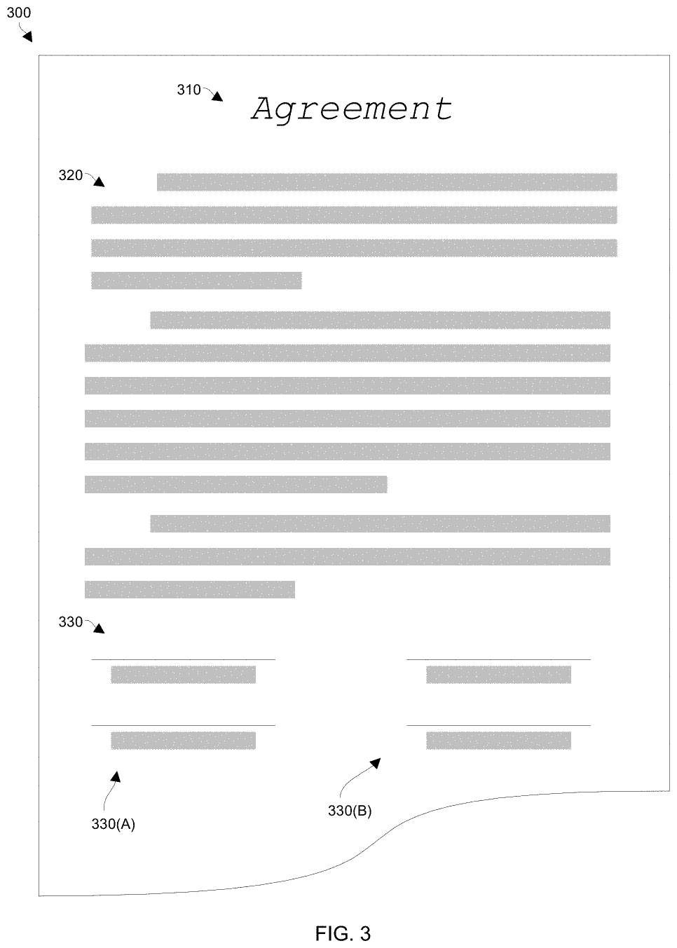

In accordance with certain embodiments, the signing parties are restricted to providing signature input to only certain input fields. For example, a first seller may be provided with privileges to complete a first set of input fields just for the first seller, a second seller may be provided with privileges to complete a second set of input fields just for the second seller, a first buyer may be provided with privileges to complete a third set of input fields just for the first buyer, and so on. Such restrictions may be imposed in a variety of ways such as via different network links to the document where the different links (or metadata within the links) provide different signing privileges, requiring initial enrollment by the parties and then offering document completion abilities via logging into respective accounts, requiring the parties to enter unique codes/passwords/etc., and so on. Further details will now be provided with reference to FIGS. 3 through 6.

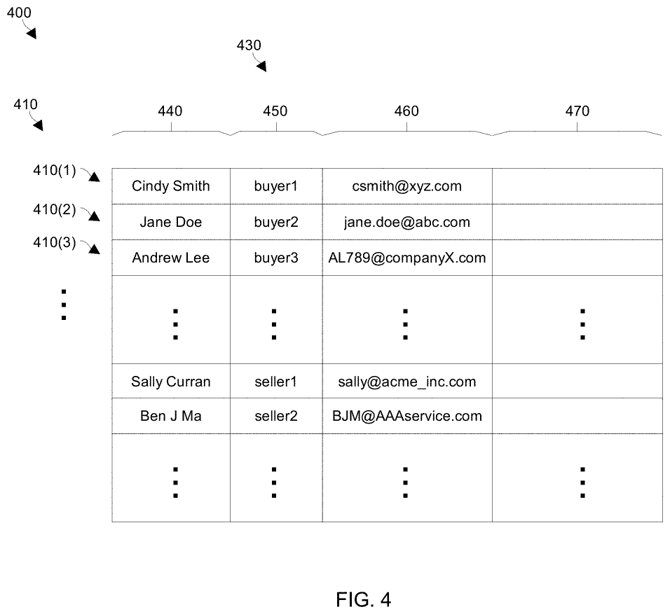

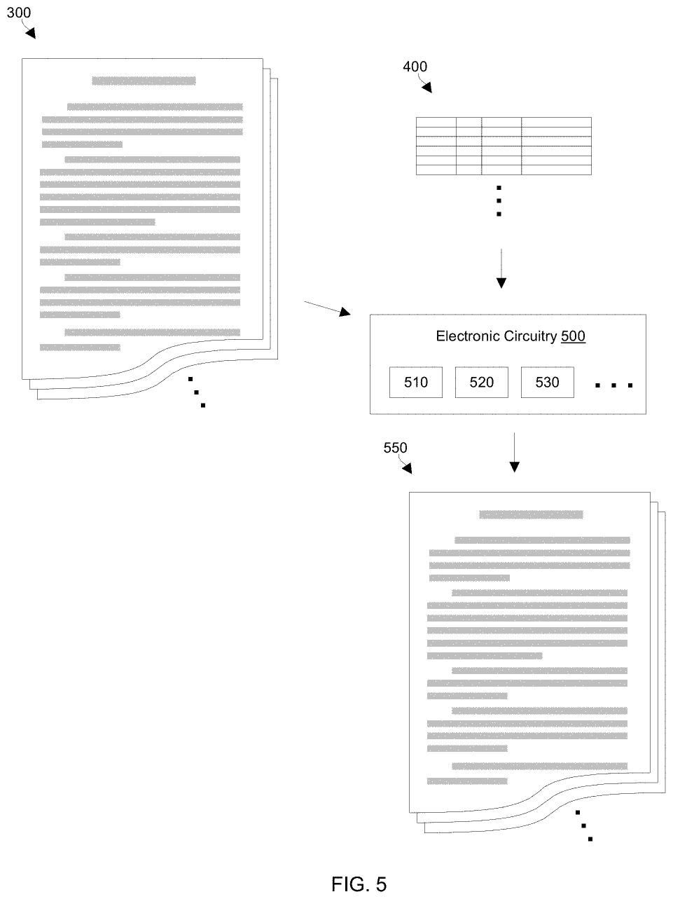

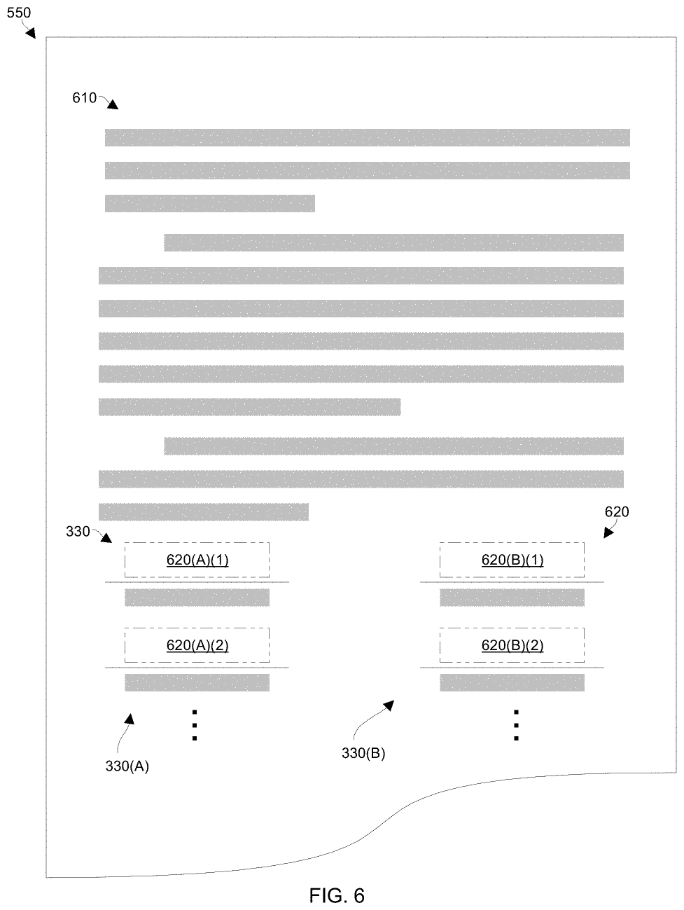

FIGS. 3 through 6 show certain details involved in automated role-based signature field placement during document preparation in accordance with certain embodiments. FIG. 3 shows an example image of a document which may be used as input. FIG. 4 shows example signer entries which may be used as input. FIG. 5 shows certain details for electronic circuitry that performs automated role-based signature field placement. FIG. 6 shows an example modified version of a document which is ready for electronic signature as provided by the electronic circuitry.

As best seen in FIG. 3, suitable input includes an example document 300 having a variety of sections or portions such as a first section 310, a second section 320, and signing section 330. By way of example, the first section 310 may include a title, language identifying parties, language identifying certain property, services, objects, and so on. The second section 320 may include terms, agreement details, conditions, requirements, and so on. The signing section 330 includes a set of signing locations for signing by a set of parties sign in order to complete the document, e.g., signing locations 330(1) for one side of a transaction, and other signing locations 330(2) for another side of the transaction. An image of the document 300 may be viewed by a user interface of a user device 102 operated by the preparer (e.g., see the user device 102(1) in FIG. 1).

One should appreciate that other documents 300 may include other formats and more or less document sections. Along these lines, a document 300 may be a single page or include multiple pages. Additionally, a document 300 may include multiple signing sections 330. Furthermore, a document 300 may include other types of sections (e.g., indexes, addendums, amendments, schedules, other parts, figures, tables, combinations thereof, etc.) that may or may not require completion by a signing party (e.g., initials at the bottom of each page, check marks agreeing to or acknowledging certain conditions, etc.).

One should further appreciate that the document 300 itself may be used as input (e.g., a text file, an editable .pdf, an HTML file, an XML file, etc.). Alternatively, an image of the document 300 may be used as input (e.g., a bitmap, a .jpg, a non-editable .pdf, a scan, etc.). For ease of explanation, certain portions of this disclosure may describe use of “a document” for simplicity but it should be understood that such sections may actually refer to using “an image of the document” instead.

As best seen in FIG. 4, suitable input for automated role-based signature field placement further includes signing entries 410(1), 410(2), 410(3), . . . (collectively, signing entries 410) which may be input by the preparer. The particular number of signing entries 410 may depend on the number of parties signing the document 300.

By way of example, the signing entries 410 include various fields such as a name field 440, a role field 450, a contact information field 460, and other fields 470. The name field 440 of individual signing entries 410 is constructed and arranged to store a name that refers to a particular party signing the document. The role field 450 of individual signing entries 410 is constructed and arranged to identify a particular role for the particular party (e.g., via a unique keyword or term such as buyer1, buyer2, seller1, etc.). The contact information field 460 of individual signing entries 410 is constructed and arranged to store contact information for the particular party (e.g., an email address, a cell phone number, etc.). The other fields 470 of individual signing entries 410 are constructed and arranged to identify other information for the particular party (e.g., gender, age, suffix, etc.).

It should be understood that the signing entries 400 may be input incrementally at different times, all at once, downloaded from another device, and so on. Moreover, the preparer may update the information in any of the fields 430, and/or delete/add signing entries 400 over time.

As best seen in FIG. 5, during automated role-based signature field placement, the document 300 and the signing entries 400 are provided to electronic circuitry 500 as input. The electronic circuitry 500 then prepares the document 300 for electronic signature by multiple persons. To this end, the electronic circuitry 500 includes contextual determination circuitry 510, modification circuitry 520, and versioning circuitry 530.

The contextual determination circuitry 510 identifies locations within the document 300 at which different persons are to provide signatures. Such identification is based on the document 300 and the signing entries 400 which contain information about roles of the different persons to complete a transaction with use of the document 300.

In accordance with certain embodiments, the contextual determination circuitry 510 initially detects possible signing areas in the document 300. In particular, the contextual determination circuitry 510 may make inferences as to which types of signing areas exist (e.g., buyer/seller, lessor/lessee, customer/service provider, etc.) based on the roles identified by the signing entries 400.

Then, the contextual determination circuitry 510 binds (or maps) signer roles to the possible signing areas based on the roles identified by the signing entries 400. Such binding essentially pairs the signing roles as identified by the signing entries 400 to the possible signing areas thus identifying the signing locations. That is, the contextual determination circuitry 510 creates pairings formally assigning certain signing roles to the detected signing areas.

In accordance with certain embodiments, the contextual determination circuitry 510 uses at least one of computer vision, image processing and/or optical character recognition to deduce possible signing areas within the document 300. For example, among other things, computer vision may be employed to separate the various sections of the document to identify individual signing areas and the possible roles for the signing areas. As another example, image processing may be employed to discern blank regions, lines and other objects to receive signer input (e.g., based on roles), among other things. As yet another example, optical character recognition may be employed to textually determine which possible signing areas are for different roles, e.g., a line for a seller signature, another line for a second seller signature, a line for a buyer signature, etc. Other smart detection operations may be employed as well such as keyword searching, analytics, artificial intelligence, etc. to ascertain appropriate signing areas within the document 300.

One should appreciate that, using such contextual determination tools, the contextual determination circuitry 510 is able to effectively and efficiently detect determine signing locations. For example, such tools are able to locate blank lines, whitespaces, etc. intended to receive signatures. Additionally, such tools are able to distinguish which areas are to be signed by which roles, e.g., based on keywords, labeling, related text, etc. adjacent the lines, whitespaces, etc. Moreover, other techniques are available to properly identify signing locations with greater certainty such as via object detection, pattern recognition, artificial intelligence, machine learning, and so on.

Then, the modification circuitry 520 of the electronic circuitry 500 modifies the document 300 to include input fields at the identified signing locations. The input fields are objects (or constructs) configured to receive electronic signatures from the parties identified by the signing entries 400. In particular, based on the signing entries 400, the modification circuitry 520 specifies the signing parties that are allowed to electronically sign the input fields. The modification circuitry 520 may specify other information for the input fields as well such as input type (e.g., full signature, initials, other, etc.), location (e.g., page number, X-Y coordinates, etc.), field size, font, and so on.

Next, the versioning circuitry 530 of the electronic circuitry 500 provides a modified version 550 of the document 300 that includes the input fields for the different persons to electronically sign. The versioning circuitry 530 may store the modified version 550 at a central location (e.g., see the electronic signature platform 104 in FIG. 1) for review by the preparer and eventual access by the various signing parties.

As best seen in FIG. 6, the modified version 550 of the document 300 includes input fields 620 within the signing section 330 of the document 300. By way of example, a first input field 620(A)(1) and a second input field 620(A)(2) reside over respective signing locations 330(A) for a first side of a transaction. Similarly, a third input field 620(B)(1) and a fourth input field 620(B)(2) reside over respective signing locations 330(B) for a second side of the transaction.

An image of the modified version 550 of the document 300 may be viewed by the user interface of the user device 102 operated by the preparer. It should be understood that only one page of the document 300 is shown in FIG. 6 for simplicity. However, in some situations, the modified version 550 of the document 300 may include multiple pages, and individual pages may have any number of input fields 620 (e.g., zero, one, two, three, four, etc.).

After the preparer reviews the modified version 550 of the document 300 to confirm the modified version 550 has been properly prepared for electronic signature, the preparer instructs the signing parties (e.g., via respective email messages) to electronically sign the modified version 550 of the document 300. The modified version 550 of the document 300 is considered to be fully completed once all of the parties have completed all of the input fields 620.

It should be understood that, prior to informing the signing parties that the document 300 is ready for signing, the preparer has the ability to make alterations and/or add updates to the modified version 550 of the document 300 if desired. In particular, the electronic circuitry 500 allows the preparer to make various changes. Examples of such changes include adding the preparer's name, adding a date (or timestamp) of preparation, moving field locations, adjusting field sizes, and so on.

It should be further understood that the preparer may also allow the electronic circuitry 500 to make certain decisions and/or adjustments before providing the modified version 550. For example, suppose that the signer entries 400 identifies four sellers and two buyers, but that the electronic circuitry 500 detects three possible signing areas for sellers and three possible signing areas for buyers. In such a situation, the electronic circuitry 500 is able to adjust the modified version 550 so that the modified version 550 has the proper number of buyer input fields 620 and seller input fields 620.

Along these lines, in accordance with certain embodiments, if the electronic circuitry 500 determines that too many signing locations for a particular signing role exist because more signing locations for that signing role are discovered than there are signing entries 400 for that signing role, the electronic circuitry 500 leaves the unneeded signing areas unmapped. In some arrangements, the electronic circuitry 500 deletes unneeded signing locations.

Similarly, suppose that the electronic circuitry 500 determines that more signing locations for a particular signing role are needed because fewer signing locations for that signing role are discovered than signing entries 400 for that signing role. In this situation, the electronic circuitry 500 may add one or more signing locations and fields for that signing role.

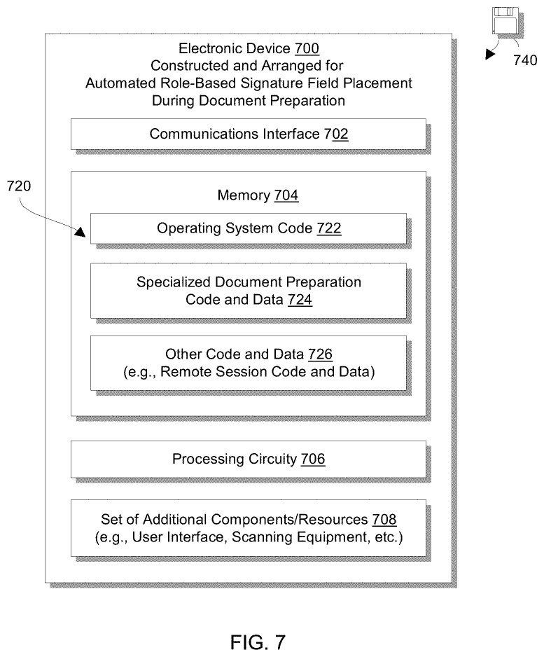

Furthermore, in accordance with certain embodiments, the signing entries 400 define a particular signer order (or priority). Such a signer order may be defined by the order of the signing entries 400, the roles themselves (e.g., seller1, seller2, seller3, etc.), or via other data (e.g., the other fields 470 of the signing entries 410). Based on the signer order, the electronic circuitry 500 assigns signing parties (e.g., by mapping the signer entries 400 to the input fields) in a manner that preserves the signer order in the document 300. Accordingly, one viewing the document 300 will see the input fields in the same signer order as defined by the signing entries 400. Further details will now be provided with reference to FIG. 7.

FIG. 7 is a view of an electronic device 700 which is suitable for automated role-based signature field placement during document preparation. The electronic device 700 includes a communications interface 702, memory 704, processing circuitry 706, and a set of additional components/resources 708.

The communications interface 702 is constructed and arranged to connect the electronic device 700 to the communications medium 108 (also see FIG. 1). Accordingly, the communications interface 702 enables the electronic device 700 to communicate with the other components of the computing environment 100 such as user devices 102, a storefront server (e.g., see the other devices 106 in FIG. 1), and so on. Such communications may be line-based, wireless, combinations thereof, and so on. Moreover, such communications may utilize a variety of protocols (e.g., IP, cellular, fiber optic, RF, etc.).

The memory 704 is intended to represent both volatile storage (e.g., DRAM, SRAM, etc.) and non-volatile storage (e.g., flash memory, magnetic disk drives, etc.). The memory 704 stores a variety of software constructs 720 including an operating system 722, specialized document preparation code and data 724, and other code and data 726.

The processing circuitry 706 is constructed and arranged to operate in accordance with the various software constructs 720 stored in the memory 704. In particular, the processing circuitry 706, when executing the operating system 722, manages various resources of the electronic device 700 (e.g., memory allocation, processor cycles, security, etc.). Additionally, the processing circuitry 706, when operating in accordance with the specialized document preparation code and data 724, is constructed and arranged to perform automated role-based signature field placement during document preparation. Furthermore, the processing circuitry 706, when operating in accordance with the other code and data 724, is constructed and arranged to perform other operations such as provide access to a remote desktop environment.

It should be understood that the above-mentioned processing circuitry 706 may be implemented in a variety of ways including one or more processors (or cores) running specialized software, application specific ICs (ASICs), field programmable gate arrays (FPGAs) and associated programs, discrete components, analog circuits, other hardware circuitry, combinations thereof, and so on. In the context of one or more processors executing software, a computer program product 740 is capable of delivering all or portions of the software to the electronic device 700. The computer program product 740 has a non-transitory and non-volatile computer readable medium that stores a set of instructions to control one or more operations of the electronic device 700. Examples of suitable computer readable storage media include tangible articles of manufacture and apparatus that store instructions in a non-volatile manner such as CD-ROM, flash memory, disk memory, tape memory, and the like.

The additional components/resources 708 refers to various other componentry such as a user interface to receive user input and provide user output, scanning equipment to input an image of a physical document, and so on.

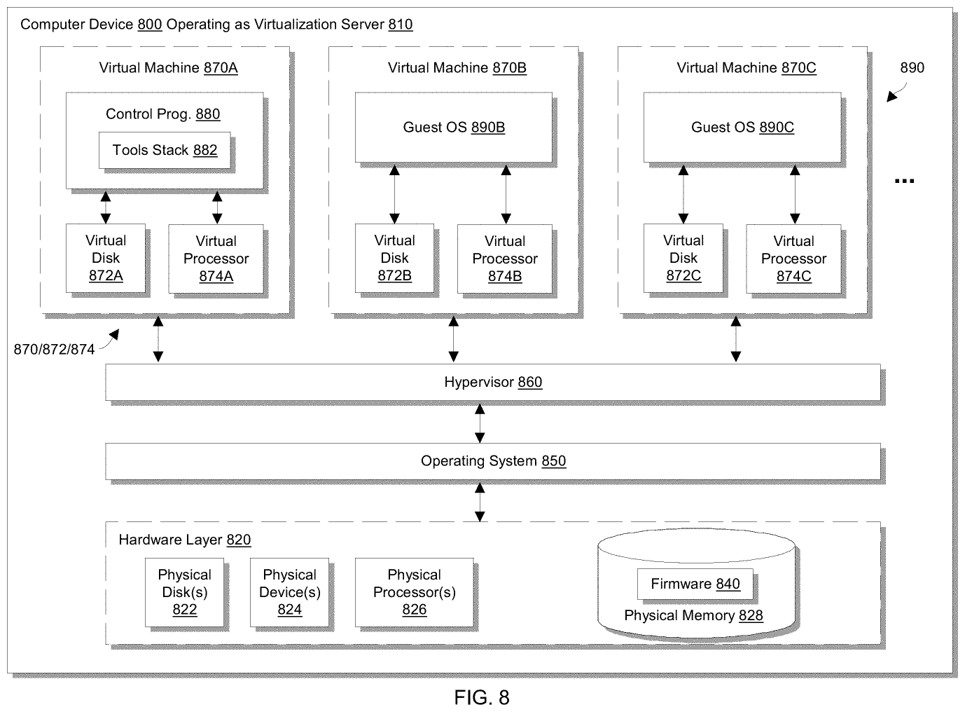

During operation, the electronic device 700 is able to perform the procedure 200 of FIG. 2. Along these lines, the electronic device 700 includes at least a portion of the electronic circuitry described above in connection with FIGS. 3 through 6. Further details will now be provided with reference to FIG. 8.

FIG. 8 shows a computer device 800 operating as a virtualization server 810 which is suitable for providing document preparation and signing services within the computing environment in accordance with certain embodiments. It should be understood that FIG. 8 shows a high-level architecture of an illustrative desktop virtualization system. Such a system is suitable for use as at least a portion of the electronic signature platform 104 (also see FIG. 1).

As shown in FIG. 8, the desktop virtualization system may be a single-server or multi-server system, or a cloud system, including at least one computer device 800 operating as a virtualization server 810 configured to provide virtual desktops and/or virtual applications to one or more client access devices (e.g., user devices 102). As used herein, a desktop may refer to a graphical environment (e.g., a graphical user interface) or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per physical device) or virtual (e.g., many instances of an OS running on a single physical device). Each application may be executed on a local device, or executed on a remotely located device (e.g., remoted).

The computer device 800 may be configured as a virtualization server in a virtualization environment, for example, a single-server, multi-server, or cloud computing environment. Virtualization server 810 illustrated in FIG. 8 may be deployed as and/or implemented by one or more embodiments of the earlier-mentioned electronic signature platform 104 or by other known computing devices. Included in virtualization server 810 is hardware layer 820 that may include one or more physical disks 822, one or more physical devices 824, one or more physical processors 826, and one or more physical memories 828. In some embodiments, firmware 840 may be stored within a memory element in physical memory 828 and be executed by one or more of physical processors 826. Virtualization server 810 may further include operating system 850 that may be stored in a memory element in physical memory 828 and executed by one or more of physical processors 826. Still further, hypervisor 860 may be stored in a memory element in physical memory 828 and be executed by one or more of physical processors 826. Presence of operating system 850 may be optional such as in a case where the hypervisor 860 is a Type A hypervisor.

Executing on one or more of physical processors 826 may be one or more virtual machines 870A, 870B, 870C, . . . (generally, VMs 870). The VMs 870A, 870B, 870C, . . . include respective virtual disks 872A, 872B, 872C, . . . (generally, virtual disks 872) and respective virtual processors 874A, 874B, 874C, . . . (generally, virtual processors 874).

In some embodiments, the first VM 870A may execute, using virtual processor 874A, control program 880 that includes tools stack 882. Control program 880 may be referred to as a control virtual machine, Domain 0, Dom0, or other virtual machine used for system administration and/or control. In some embodiments, one or more VMs 870B, 870C, . . . may execute, using their respective virtual processors 874B, 874C, . . . , guest operating systems 890B, 890C, . . . (generally, guest operating systems 890).

Physical devices 824 may include, for example, a network interface card, a video card, an input device (e.g., a keyboard, a mouse, a scanner, etc.), an output device (e.g., a monitor, a display device, speakers, a printer, etc.), a storage device (e.g., an optical drive), a Universal Serial Bus (USB) connection, a network element (e.g., router, firewall, network address translator, load balancer, virtual private network (VPN) gateway, Dynamic Host Configuration Protocol (DHCP) router, etc.), or any device connected to or communicating with virtualization server 810. Physical memory 828 in hardware layer 820 may include any type of memory. Physical memory 828 may store data, and in some embodiments may store one or more programs, or set of executable instructions. FIG. 8 illustrates an embodiment where firmware 840 is stored within physical memory 828 of virtualization server 810. Programs or executable instructions stored in physical memory 828 may be executed by the one or more processors 826 of virtualization server 810.

Virtualization server 810 may also include hypervisor 860. In some embodiments, hypervisor 860 may be a program executed by processors 826 on virtualization server 810 to create and manage any number of virtual machines 870. Hypervisor 860 may be referred to as a virtual machine monitor, or platform virtualization software. In some embodiments, hypervisor 860 may be any combination of executable instructions and hardware that monitors virtual machines 870 executing on a computing machine. Hypervisor 860 may be a Type 2 hypervisor, where the hypervisor executes within operating system 850 executing on virtualization server 810. Virtual machines may then execute at a layer above hypervisor 860. In some embodiments, the Type 2 hypervisor may execute within the context of a user's operating system such that the Type 2 hypervisor interacts with the user's operating system. In other embodiments, one or more virtualization servers 810 in a virtualization environment may instead include a Type 1 hypervisor (not shown). A Type 1 hypervisor may execute on virtualization server 810 by directly accessing the hardware and resources within hardware layer 810. That is, while Type 2 hypervisor 860 accesses system resources through host operating system 850, as shown, a Type 1 hypervisor may directly access all system resources without host operating system 810. A Type 1 hypervisor may execute directly on one or more physical processors 826 of virtualization server 810, and may include program data stored in physical memory 828.

Hypervisor 850, in some embodiments, may provide virtual resources to guest operating systems 890 or control programs 880 executing on virtual machines 870 in any manner that simulates operating systems 890 or control programs 880 having direct access to system resources. System resources can include, but are not limited to, physical devices 822, physical disks 824, physical processors 826, physical memory 828, and any other component included in hardware layer 820 of virtualization server 810. Hypervisor 860 may be used to emulate virtual hardware, partition physical hardware, virtualize physical hardware, and/or execute virtual machines that provide access to computing environments. In still other embodiments, hypervisor 860 may control processor scheduling and memory partitioning for virtual machines 870 executing on virtualization server 810. Examples of hypervisor 860 may include those manufactured by VMWare, Inc., of Palo Alto, Calif.; Xen Project® hypervisor, an open source product whose development is overseen by the open source XenProject.org community; Hyper-V®, Virtual Server®, and Virtual PC® hypervisors provided by Microsoft Corporation of Redmond, Wash.; or others. In some embodiments, virtualization server 810 may execute hypervisor 860 that creates a virtual machine platform on which guest operating systems 890 may execute. In these embodiments, virtualization server 810 may be referred to as a host server. An example of such a virtualization server is Citrix Hypervisor® provided by Citrix Systems, Inc., of Fort Lauderdale, Fla.

Hypervisor 860 may create one or more virtual machines 870 in which guest operating systems 890 execute. In some embodiments, hypervisor 860 may load a virtual machine image to create virtual machine 870. The virtual machine image may refer to a collection of data, states, instructions, etc. that make up an instance of a virtual machine. In other embodiments, hypervisor 860 may execute guest operating system 890 within virtual machine 870. In still other embodiments, virtual machine 870 may execute guest operating system 890.

In addition to creating virtual machines 870, hypervisor 860 may control the execution of at least one virtual machine 870. In other embodiments, hypervisor 860 may present at least one virtual machine 870 with an abstraction of at least one hardware resource provided by virtualization server 810 (e.g., any hardware resource available within hardware layer 810). In other embodiments, hypervisor 860 may control the manner in which virtual machines 870 access physical processors 826 available in virtualization server 810. Controlling access to physical processors 826 may include determining whether virtual machine 870 should have access to processor 826, and how physical processor capabilities are presented to virtual machine 870.

As shown in FIG. 8, virtualization server 810 may host or execute one or more virtual machines 870. Virtual machine 870 may be a set of executable instructions and/or user data that, when executed by processor 826, may imitate the operation of a physical computer such that virtual machine 870 can execute programs and processes much like a physical computing device. While FIG. 8 illustrates an embodiment where virtualization server 810 hosts three virtual machines 870, in other embodiments virtualization server 810 may host any number of virtual machines 870. Hypervisor 860, in some embodiments, may provide each virtual machine 870 with a unique virtual view of the physical hardware, including memory 828, processor 826, and other system resources 822, 824 available to that virtual machine 870. In some embodiments, the unique virtual view may be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 860 may create one or more unsecure virtual machines 870 and one or more secure virtual machines 870. Unsecure virtual machines 870 may be prevented from accessing resources, hardware, memory locations, and programs that secure virtual machines 870 may be permitted to access. In other embodiments, hypervisor 810 may provide each virtual machine 870 with a substantially similar virtual view of the physical hardware, memory, processor, and other system resources available to virtual machines 870.

Each virtual machine 870 may include a respective virtual disk 872 and respective virtual processor 874. Virtual disk 872, in some embodiments, may be a virtualized view of one or more physical disks 822 of virtualization server 810, or a portion of one or more physical disks 822 of virtualization server 810. The virtualized view of physical disks 822 may be generated, provided, and managed by hypervisor 860. In some embodiments, hypervisor 860 may provide each virtual machine 870 with a unique view of physical disks 822. Thus, in these embodiments, particular virtual disk 822 included in each virtual machine 870 may be unique when compared with other virtual disks 872.

Virtual processor 874 may be a virtualized view of one or more physical processors 826 of virtualization server 810. In some embodiments, the virtualized view of physical processors 826 may be generated, provided, and managed by hypervisor 860. In some embodiments, virtual processor 874 may have substantially all of the same characteristics of at least one physical processor 826. In other embodiments, virtual processor 874 may provide a modified view of physical processors 826 such that at least some of the characteristics of virtual processor 874 are different from the characteristics of the corresponding physical processor 826.

It should be understood that the computer device 800 operating as the virtualization server 810 may be configured to provide electronic signature services as a cloud service. Along these lines, various users involved in preparing and/or electronically signing a document are able to access the cloud service.

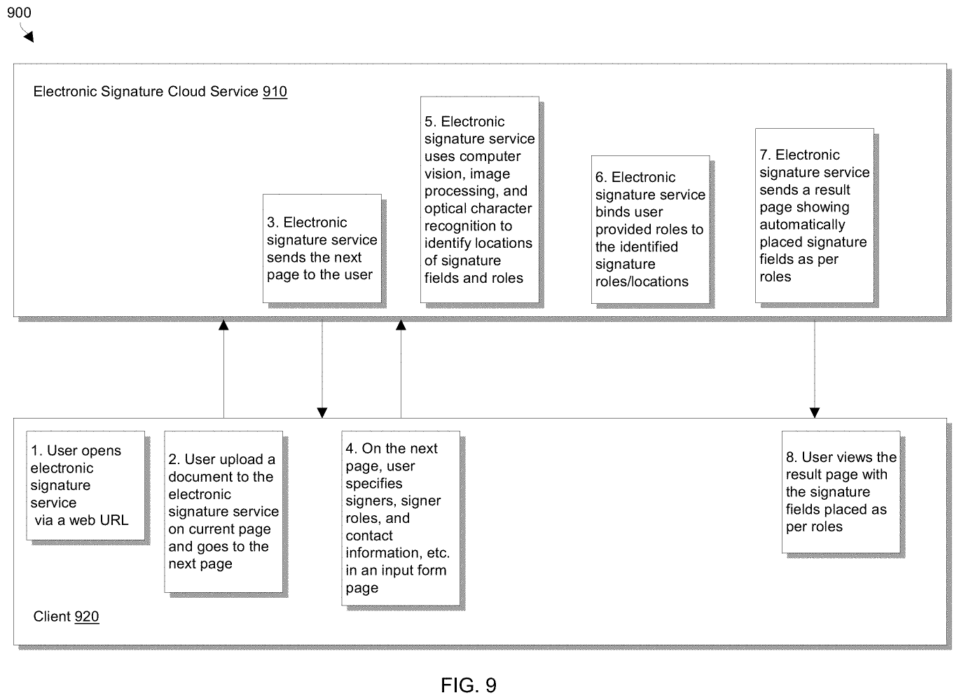

FIG. 9 shows a sequence diagram 900 describing activities and communications between an electronic signature cloud service 910 and a client 920 operated by a user in accordance with certain embodiments. Such an electronic signature cloud service 910 may be provided by equipment which is accessible over a network (e.g., see the electronic signature platform 104 in FIG. 1). A suitable client 920 is equipment operated by a user, i.e., a human preparer (e.g., see the user device 102(1) in FIG. 1).

It should be understood that the client 920 may cache user input and convey the user input to the electronic signature cloud service 910 in a variety of ways. In some embodiments, the client 920 caches the user input as well as immediately conveys the user input to the electronic signature cloud service 910 thus enabling the electronic signature cloud service 910 to remain synchronized with the client 920 in real time. In other embodiments, the client 920 caches the user input, and waits for one or more events before conveying the cached user input to the electronic signature cloud service 910 (e.g., in response to the user navigating to a next page of the document) thus reducing consumption of network resources. Other scenarios are suitable for use as well such as the client 920 caching the user input, and periodically conveying the cached user input to the electronic signature cloud service 910 (e.g., every 5 seconds, every 10 seconds, etc.), combinations thereof, and so on.

At 1, while operating the client 920, the user, acting in his/her role as preparer of a document for signature, opens or otherwise initiates a session from the electronic signature cloud service 910 via a web URL. In some arrangements, the user may open the session via a remote desktop hosted by a remote desktop server (e.g., see the computer device 800 operating as a virtualization server 810 in FIG. 8).

At 2, in a webpage (e.g., a current web page) of the session, the user uploads a document to the electronic signature cloud service 910. The user then directs (e.g., navigates) the client 920 to a new web page of the session.

At 3, in response to the uploaded document and navigation by the user, the electronic signature cloud service 910 sends the next web page to the client 920. The next web page prompts the user to enter signer information (e.g., see the signer entries 400 in FIG. 4).

At 4, the user specifies signers, signer roles (i.e., user provided roles), contact information, etc. To this end, the web page may be an input form page that displays input fields, queries, menu items, dialog boxes, etc. to the user thus prompting the user for the signer information. The client 920 sends this information the electronic signature cloud service 910 for processing.

At 5, the electronic signature cloud service 910 uses a variety of techniques to contextually evaluate/analyze the document based on the information provided by the user. Along these lines, the electronic signature cloud service 910 may apply computer vision, image processing, optical character recognition, combinations thereof, etc. to an image of the document to identify locations of signature fields and signing roles for the signature fields.

At 6, the electronic signature cloud service 910 binds, assigns or otherwise maps the user-provided roles to the identified signature roles/locations. Such binding imposes an association or mapping between particular parties and signing locations.

At 7, the electronic signature cloud service 910 sends a result page containing a modified version of the document to the client 920. In particular, the result page displays the signature fields that were automatically placed at the identified signing locations by the electronic signature cloud service 910.

At 8, the user then views the result page containing the modified version of the document with the signature fields that were automatically placed at the identified signing locations by the electronic signature cloud service 910. The user may make adjustments and confirms that the document is ready for electronic signature.

At this point, the user may inform the signers that the document is available for signing. In some arrangements, the user directs the electronic signature cloud service 910 to send email messages containing links to the document and may rely on the electronic signature cloud service 910 to impose authentication/security, proper signature completion, maintain/manage proof of signing, and so on.

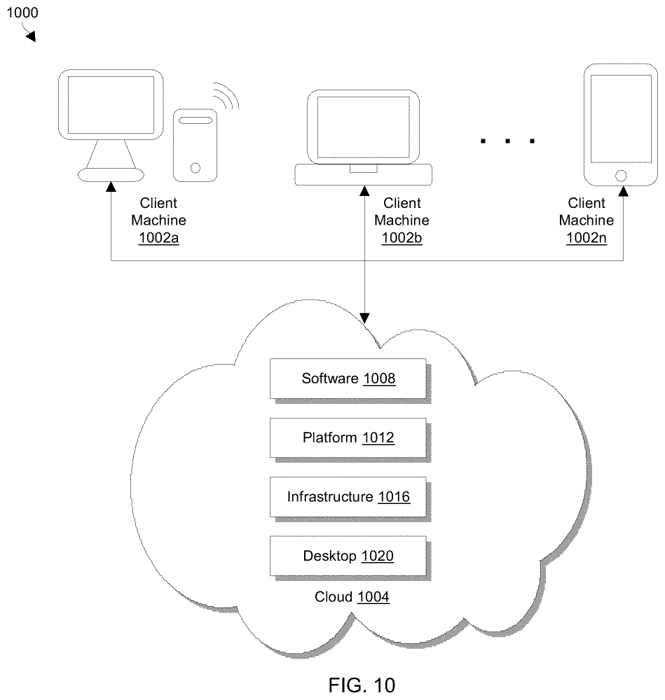

Referring to FIG. 10, a cloud computing environment 1000 is depicted, which may also be referred to as a cloud environment, cloud computing or cloud network. The cloud computing environment 1000 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 1000, one or more clients (or user devices) 1002a-1002n (such as those described above) are in communication with a cloud network 1004. The cloud network 1004 may include back-end platforms, e.g., servers, storage, server farms or data centers. The users or clients 1002a-1002n can correspond to a single organization/tenant or multiple organizations/tenants. More particularly, in one example implementation the cloud computing environment 1000 may provide a private cloud serving a single organization (e.g., enterprise cloud). In another example, the cloud computing environment 1000 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 1000 may provide a hybrid cloud that is a combination of a public cloud and a private cloud. Public clouds may include public servers that are maintained by third parties to the clients 1002a-1002n or the enterprise/tenant. The servers may be located off-site in remote geographical locations or otherwise.

The cloud computing environment 1000 can provide resource pooling to serve multiple users via clients 1002a-1002n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 1000 can provide on-demand self-service to unilaterally provision computing capabilities (e.g., server time, network storage) across a network for multiple clients 1002a-1002n. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 1000 can provide an elasticity to dynamically scale out or scale in response to different demands from one or more clients 1002. In some embodiments, the cloud computing environment 1000 can include or provide monitoring services to monitor, control and/or generate reports corresponding to the provided shared services and resources.

In some embodiments, the cloud computing environment 1000 may provide cloud-based delivery of different types of cloud computing services, such as Software as a service (SaaS) 1008, Platform as a Service (PaaS) 1012, Infrastructure as a Service (IaaS) 1016, and Desktop as a Service (DaaS) 1020, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Wash. (herein “Azure”), or AMAZON WEB SERVICES provided by Amazon.com, Inc., of Seattle, Wash. (herein “AWS”), for example. In the case of Citrix Cloud, Citrix Workspace app may be used as a single-entry point for bringing apps, files and desktops together (whether on-premises or in the cloud) to deliver a unified experience.

### FURTHER EXAMPLE EMBODIMENTS

The following examples pertain to further embodiments, from which numerous permutations and configurations will be apparent.

Example 1 includes a method of preparing a document for electronic signature by multiple persons. The method includes identifying locations within a document at which different persons are to provide signatures based content of the document and information about roles of the different persons to complete a transaction with use of the document; modifying the document or an image of that document to include input fields at the identified locations, the input fields being configured to receive electronic signatures; and providing a modified version of the document or image that includes the input fields for the different persons to electronically sign.

Example 2 includes the subject matter of Example 1, wherein identifying the locations within the document includes detecting possible signing areas on the image of the document, and discerning the locations from the possible signing areas based on signer entries describing signing parties, the signer entries storing the information about the roles of the different persons.

Example 3 includes the subject matter of Example 2, wherein detecting the possible signing areas on the image includes applying at least one of computer vision, image processing and optical character recognition to the image to deduce the possible signing areas from the image.

Example 4 includes the subject matter of any of Examples 2 and 3, wherein the signer entries includes a first signer entry describing a first signing party and a second signer entry describing a second signing party. Additionally, discerning the locations from the possible signing areas includes selecting a first possible signing area as a first location for the first signing party to electronically sign, and selecting a second possible signing area as a second location for the second signing party to electronically sign.

Example 5 includes the subject matter of any of Examples 2 through 4, further comprising, prior to identifying the locations within the document, creating the signer entries describing the signing parties, the signer entries defining signing roles for the signing parties.

Example 6 includes the subject matter of Example 5, wherein discerning the locations from the possible signing areas includes binding the signing roles defined by the signer entries to the possible signing areas.

Example 7 includes the subject matter of Example 6, wherein discerning the locations from the possible signing areas further includes, after the signing roles defined by the signer entries are bound to the possible signing areas, mapping the signing parties to at least some of the possible signing areas to select the locations.

Example 8 includes the subject matter of Example 7, wherein mapping the signing parties includes mapping a particular signing party to multiple possible signing areas to identify multiple locations for the particular signing party.

Example 9 includes the subject matter of Example 7, wherein the image includes more possible signing areas than there are signing parties. Additionally, discerning the locations from the possible signing areas further includes leaving at least one possible signing area unmapped based on the image including more possible signing areas than there are signing parties.

Example 10 includes the subject matter of Example 7, wherein the image includes less possible signing areas than there are signing parties. Additionally, discerning the locations from the possible signing areas further includes adding at least one possible signing area on the image to enable mapping each signing party to a possible signing area on the image.

Example 11 includes the subject matter of Example 7, wherein the signer entries are arranged in a signer order. Additionally, mapping the signing parties includes assigning the signer entries to the possible signing areas on the image in accordance with the signer order to preserve the signer order when subsequently modifying the document or image to include the input fields.

Example 12 includes the subject matter of any of Examples 2 through 11, wherein the document represents an agreement; and wherein the signer entries includes a first set of signer entries and a second set of signer entries, the signing role defined by each signer entry of the first set being a first contractual role in the agreement, and the signing role defined by each signer entry of the second set being a second contractual role in the agreement that is different from the first contractual role.

Example 13 includes the subject matter of any of Examples 2 through 12, discerning the locations from the possible signing areas includes assigning field types to the locations, the field types defining different types of input requested from the signing parties.

Example 14 includes the subject matter of any of Examples 2 through 13, wherein modifying the document or the image of that document includes placing the input fields at the locations in accordance with the assigned field types.

Example 15 includes the subject matter of any of Examples 2 through 14, further comprising rendering a view of the modified version of the document, the view including the image of the document and the input fields placed at the locations on the image. Example 16 includes electronic circuitry including memory, and control circuitry coupled with the memory. The memory stores instructions that, when carried out by the control circuitry, cause the control circuitry to perform a method that includes identifying locations within a document at which different persons are to provide signatures based content of the document and information about roles of the different persons to complete a transaction with use of the document, modifying the document or an image of that document to include input fields at the identified locations, the input fields being configured to receive electronic signatures, and providing a modified version of the document or image that includes the input fields for the different persons to electronically sign.

Example 17 includes a method of preparing a document for electronic signing, the method including performing an electronic contextual determination operation on an image of the document to identify signing locations on the image; situating signing fields at the signing locations; and outputting a prepared version of the document, the prepared version including the image of the document and the signing fields situated at the signing locations.

Example 18 includes the subject matter of Example 17, wherein performing the electronic contextual determination operation includes applying at least one of computer vision, image processing and optical character recognition to the image to deduce possible signing areas from the image.

Example 19 includes the subject matter of Example 17, further comprising, prior to performing the electronic contextual determination operation, creating signer entries describing signing parties, the signer entries defining signing roles for the signing parties. Additionally, performing the electronic contextual determination operation further includes identifying the signing locations from the possible signing areas based on the signer entries describing the signing parties.

Example 20 includes the subject matter of any of Examples 2 through 15 or the subject matter of any of Examples 17 through 19, wherein the signer entries include name fields storing individual party names of the signing parties, role fields storing distinct roles for the signing parties, and contact information fields storing contact information for the signing parties.

As described above, improved techniques are directed to automated role-based signature field placement during document preparation. Such techniques involve identifying signing locations within a document using information about roles of different persons to complete a transaction with use of the document. Such identification may involve electronic contextual determination using computer vision, image processing and/or optical character recognition to deduce possible signing areas within the document (or within an image of the document). The document (or the image) may then be modified automatically to include input fields for the different persons to electronically sign. Accordingly, document preparation using the improved techniques is less tedious, less time consuming, and less prone to human error.

While various embodiments of the present disclosure have been particularly shown and described, it will be understood by those skilled in the art that various changes in form and details may be made therein without departing from the spirit and scope of the present disclosure as defined by the appended claims.

For example, it should be understood that various components of the computing environment 100 (FIG. 1) are capable of being implemented in or “moved to” the cloud, i.e., to remote computer resources distributed over a network. Here, the various computer resources may be distributed tightly (e.g., a server farm in a single facility) or over relatively large distances (e.g., over a campus, in different cities, coast to coast, etc.). In these situations, the network connecting the resources is capable of having a variety of different topologies including backbone, hub-and-spoke, loop, irregular, combinations thereof, and so on. Additionally, the network may include copper-based data communications devices and cabling, fiber optic devices and cabling, wireless devices, combinations thereof, etc. Furthermore, the network is capable of supporting LAN-based communications, cellular-based communications, combinations thereof, and so on.

Additionally, certain details were provided above in connection with preparing a document for electronic signature by multiple parties by way of example. In accordance with certain embodiments, the document may be prepared for electronic signing by a single party. In such a situation, the techniques enable document preparation to be easy, efficient, and more accurate.

Moreover, certain details were provided above in connection with each party having a single role by way of example. In accordance with certain embodiments, one or more parties may have more than one role. For example, the person preparing the document may be a preparer, an acceding party, a broker, a party to a particular side of a transaction, combinations thereof, and so on.

It should be appreciated that certain conventional electronic signature products provide users/businesses the ability to upload documents, prepare the documents for e-signing, and send them to parties for signing. The parties then sign those electronic documents.

However, there are many complexities when using such conventional electronic signature products. Along these lines, for many contracts, signatures are required from multiple parties (e.g., buyer(s) and seller(s), landowner(s) and one or more tenant(s), etc.)

on each page.

Simply and naively identifying that a signature field exists on a page and being able to automatically place it may not help because:
1. The preparer/sender has to manually place a signature field and then bind or map it to a signing party.
2. At times a contract document has multiple signature fields but only few might be actually needed (e.g., a selling contract may have 4-6 places in case 4-6 buyers/co-buyers are jointly signing the contract), but there might actually be only 1-2 sellers. In such a situation, the preparer/sender may need to manually delete the auto placed signatures.

Additionally, for many contracts such as weekly boat rentals and the like, brokers or agents have to do 100s or even 1000s of such contracts and such manual placement of signatures is very challenging and tedious. Furthermore, for a 40-50 page contract, simply preparing a contract for 2 parties signing on each page may require significant effort just for a single document.

However, in accordance with certain embodiments, techniques are provided for role based multi-party automatic signature for e-signing documents. Such techniques involve automatically determining the signer role for fields discovered when initially processing an uploaded document.

Along these lines, such techniques may involve:
Contextual determination of the type/role of the signatures using computer vision, image processing and OCR
Role-based workflow where the sender/preparer can specify the roles of the signing parties
Based on the specified roles in the workflow, automatic placement and binding of the signature fields

In accordance with certain embodiments, certain processes involve:

1. Sender/Preparer navigating to a web URL for an electronic signature service

2. Sender/Preparer uploading the document (e.g., a pdf, an image, etc.)

3. Sender/Prepare specifying the roles of the signers instead of just simply adding signer1, signer2
a. e.g., Buyer1, Buyer2, Seller1, Seller2, etc.
b. e.g., Landowner1, Landowner2, Tenant1, Tenant2, Tenant3, etc. This particular input in the workflow helps electronic signature service understand how many signing parties exist and also their types

4. The electronic signature service backend processes the document uploaded in Step 2 above, where the electronic signature service employs computer vision-image processing and OCR techniques to automatically identify
i. Signature fields
ii. Role/Type of signature field (e.g., Buyer1, Buyer2, Seller1, Seller2, etc.)
iii. Order/Location of the signatures for the roles

By way of example, sometimes Seller1 and Seller2 are in the same row. However, in other cases, Seller1 is in the first row and Seller2 is in the second row, etc.

5. Roles and numbers specified in Step 3 of the workflow are bound/mapped to the roles/locations identified in Step 4

6. Signatures with their appropriate roles are automatically placed. Accordingly, the work of the preparer is less burdensome, less time consuming, and more accurate.

It should be understood that, in any of the earlier-described preparation examples, mapping the signing parties may include mapping a particular signing party to multiple possible signing areas to identify multiple locations for the particular signing party.

Additionally, in any of the earlier-described preparation examples, if the image includes more possible signing areas in a particular area than there are signing parties, the techniques may leave at least one possible signing area unmapped based on the image including more possible signing areas than there are signing parties.

Furthermore, in any of the earlier-described preparation examples, if the image includes less possible signing areas than there are signing parties, the techniques may add at least one possible signing area on the image to enable mapping each signing party to a possible signing area on the image.

Also, in any of the earlier-described preparation examples, the signer entries may be arranged in a signer order. Additionally, mapping the signing parties may involve assigning the signer entries to the possible signing areas on the image in accordance with the signer order to preserve the signer order when subsequently modifying the document or image to include the input fields.

Additionally, in any of the earlier-described preparation examples, discerning the locations from the possible signing areas may involve assigning field types to the locations. The field types define different types of input requested from the signing parties.

Furthermore, in any of the earlier-described preparation examples, modifying the document or image to include the input fields may include placing the input fields at the locations in accordance with the assigned field types.

Also, in any of the earlier-described preparation examples, the techniques may include rendering a view of the modified version of the document. The view includes the image of the document and the input fields placed at the locations on the image.

It should be further understood that the disclosed role-based discovery/identification aspects that were described above as facilitating inclusion of input fields for electronic signing of a document. However, such role-based discovery/identification improvements may have applications in other systems, fields, technological areas, and specialties as well.

Along these lines, such improvements may be used to navigate or guide different users to particular elements or components of a complex object or model such as blueprints, plans, or design specs for complex machine (e.g., an airplane). In such a situation, the improvements disclosed herein enable the circuitry to identify sections of the object/model based on certain provided roles (e.g., airplane engine specs for an engineer, controls and cockpit details for a pilot, servicing requirements for a maintenance person, and so on). In such a situation, the disclosed improvements enable circuitry to parse/scan, identify, and highlight portions of a large information-base in response to role data provided by a user. Such arrangements, modifications and enhancements are intended to belong to various embodiments of the disclosure.

What is claimed is:

1. A method of preparing a document for electronic signature by multiple persons, the method comprising:
identifying locations within a document at which different persons are to provide signatures based content of the document and information about roles of the different persons to complete a transaction with use of the document;
modifying the document or an image of that document to include input fields at the identified locations, the input fields being configured to receive electronic signatures; and
providing a modified version of the document or image that includes the input fields for the different persons to electronically sign.

2. A method as in claim 1 wherein identifying the locations within the document includes:
detecting possible signing areas on the image of the document, and
discerning the locations from the possible signing areas based on signer entries describing signing parties, the signer entries storing the information about the roles of the different persons.

3. A method as in claim 2 wherein detecting the possible signing areas on the image includes:
applying at least one of computer vision, image processing and optical character recognition to the image to deduce the possible signing areas from the image.

4. A method as in claim 2 wherein the signer entries includes a first signer entry describing a first signing party and a second signer entry describing a second signing party; and
wherein discerning the locations from the possible signing areas includes:
selecting a first possible signing area as a first location for the first signing party to electronically sign, and
selecting a second possible signing area as a second location for the second signing party to electronically sign.

5. A method as in claim 2, further comprising:
prior to identifying the locations within the document, creating the signer entries describing the signing parties, the signer entries defining signing roles for the signing parties.

6. A method as in claim 5 wherein discerning the locations from the possible signing areas includes:
binding the signing roles defined by the signer entries to the possible signing areas.

7. A method as in claim 6 wherein discerning the locations from the possible signing areas further includes:
after the signing roles defined by the signer entries are bound to the possible signing areas, mapping the signing parties to at least some of the possible signing areas to select the locations.

8. A method as in claim 7 wherein mapping the signing parties includes:
mapping a particular signing party to multiple possible signing areas to identify multiple locations for the particular signing party.

9. A method as in claim 7 wherein the image includes more possible signing areas than there are signing parties; and
wherein discerning the locations from the possible signing areas further includes:
leaving at least one possible signing area unmapped based on the image including more possible signing areas than there are signing parties.

10. A method as in claim 7 wherein the image includes less possible signing areas than there are signing parties; and
wherein discerning the locations from the possible signing areas further includes:
adding at least one possible signing area on the image to enable mapping each signing party to a possible signing area on the image.

11. A method as in claim 7 wherein the signer entries are arranged in a signer order; and
wherein mapping the signing parties includes:
assigning the signer entries to the possible signing areas on the image in accordance with the signer order to preserve the signer order when subsequently modifying the document or image to include the input fields.

12. A method as in claim 5 wherein the document represents an agreement; and
wherein the signer entries includes a first set of signer entries and a second set of signer entries, the signing role defined by each signer entry of the first set being a first contractual role in the agreement, and the signing role defined by each signer entry of the second set being a second contractual role in the agreement that is different from the first contractual role.

13. A method as in claim 2 wherein discerning the locations from the possible signing areas includes:
assigning field types to the locations, the field types defining different types of input requested from the signing parties.

14. A method as in claim 13 wherein modifying the document or the image of that document includes:
placing the input fields at the locations in accordance with the assigned field types.

15. A method as in claim 14, further comprising:
rendering a view of the modified version of the document, the view including the image of the document and the input fields placed at the locations on the image.

16. Electronic circuitry, comprising:
memory; and
control circuitry coupled with the memory; the memory storing instructions that, when carried out by the control circuitry, cause the control circuitry to perform a method that includes:
identifying locations within a document at which different persons are to provide signatures based content of the document and information about roles of the different persons to complete a transaction with use of the document,
modifying the document or an image of that document to include input fields at the identified locations, the input fields being configured to receive electronic signatures, and
providing a modified version of the document or image that includes the input fields for the different persons to electronically sign.

17. A method of preparing a document for electronic signing, the method comprising:
performing an electronic contextual determination operation on an image of the document to identify signing locations on the image;
situating signing fields at the signing locations; and
outputting a prepared version of the document, the prepared version including the image of the document and the signing fields situated at the signing locations.

18. A method as in claim 17 wherein performing the electronic contextual determination operation includes:
applying at least one of computer vision, image processing and optical character recognition to the image to deduce possible signing areas from the image.

19. A method as in claim 18, further comprising:
prior to performing the electronic contextual determination operation, creating signer entries describing signing parties, the signer entries defining signing roles for the signing parties; and
wherein performing the electronic contextual determination operation further includes:
identifying the signing locations from the possible signing areas based on the signer entries describing the signing parties.

20. A method as in claim 19 wherein the signer entries include name fields storing individual party names of the signing parties, role fields storing distinct roles for the signing parties, and contact information fields storing contact information for the signing parties.
